(19) United States
(12) Patent Application Publication
(10) Pub. No.: US 2026/0260458 A1
(43) Pub. Date: Sep. 3, 2026

(54) IMAGE CLASSIFICATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Baiqiao Xiong, Beijing (CN); Li Chen, Beijing (CN); Xu Wang, Beijing (CN)

(21) Appl. No.: 19/159,785

(22) PCT Filed: Feb. 28, 2024
(86) PCT No.: PCT/CN2024/079144

§ 371 Date: Aug. 26, 2025

(30) Foreign Application Priority Data
Mar. 7, 2023 (CN) 202310254832.5

(51) Int. Cl. G06V 10/764; G06V 10/778; G06V 10/80; G06V 20/70; G06V 40/40

(52) U.S. Cl. CPC G06V 10/764; G06V 10/7784; G06V 10/806; G06V 20/70; G06V 40/45

(57) ABSTRACT

Embodiments of the present disclosure disclose an image classification method and apparatus, an electronic device, and a storage medium. The method includes: extracting a first image feature of an image to be classified; extracting a first text feature of each description text in a description text set, wherein the description text set corresponds to a target image classification task, each description text is used to describe a respective image category under the target image classification task, and the description text set is updated as image categories are updated; determining a target text feature matching the first image feature from the first text features; and determining a target category of the image to be classified based on an image category corresponding to the target text feature.

### CROSS-REFERENCE TO RELATED APPLICATION(S)

The present application claims priority to Chinese Patent Application No. 202310254832.5, entitled “IMAGE CLASSIFICATION METHOD AND APPARATUS, ELECTRONIC DEVICE, AND STORAGE MEDIUM”, filed with the China National Intellectual Property Administration on Mar. 7, 2023, which is incorporated herein by reference in its entirety.

### FIELD

Embodiments of the present disclosure relate to the technical field of data processing, and in particular, to an image classification method and apparatus, an electronic device, and a storage medium.

### BACKGROUND

Silent liveness detection may be considered as a detection technology that directly determines whether a user in front of a camera is a real person without requiring the user to cooperate to complete prompted actions. The silent liveness detection is now commonly implemented through a data-driven deep learning algorithm. Training data used for model learning may be considered a decisive factor for an algorithm performance effect.

At present, when the algorithm encounters a novel type of facial spoofing attack, the time span of an algorithm iteration process (e.g., including design/collection and processing of attack data, model training based on the attack data, and model update) is relatively long. Existing methods cannot quickly identify novel attacks, which results in higher security risks for a system with the algorithm, potentially leading to significant losses when the novel attacks emerge.

### SUMMARY

Embodiments of the present disclosure provide an image classification method and apparatus, an electronic device, and a storage medium, which can achieve rapid recognition of a novel image category.

In a first aspect, embodiments of the present disclosure provide an image classification method, including:
extracting a first image feature of an image to be classified;
extracting a first text feature of each description text in a description text set, wherein the description text set corresponds to a target image classification task, each description text is used to describe a respective image category under the target image classification task, and the description text set is updated as image categories are updated;
determining a target text feature matching the first image feature from the first text features; and
determining a target category of the image to be classified based on an image category corresponding to the target text feature.

In a second aspect, embodiments of the present disclosure further provide an image classification apparatus, including:
an image feature extraction module, configured to extract a first image feature of an image to be classified;
a text feature extraction module, configured to extract a first text feature of each description text in a description text set, wherein the description text set corresponds to a target image classification task, each description text is used to describe a respective image category under the target image classification task, and the description text set is updated as image categories are updated;
an image-text feature matching module, configured to determine a target text feature matching the first image feature from the first text features; and
a classification module, configured to determine a target category of the image to be classified based on an image category corresponding to the target text feature.

In a third aspect, embodiments of the present disclosure further provide an electronic device. The electronic device includes:
one or more processors; and
a storage means, configured to store one or more programs,
where the one or more programs, when executed by the one or more processors, cause the one or more processors to implement the image classification method according to any of the embodiments of the present disclosure.

In a fourth aspect, embodiments of the present disclosure further provide a storage medium including computer-executable instructions. The computer-executable instructions, when executed by a computer processor, are configured to perform the image classification method according to any of the embodiments of the present disclosure.

### BRIEF DESCRIPTION OF THE DRAWINGS

The above and other features, advantages, and aspects of various embodiments of the present disclosure will become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of an image classification method according to embodiments of the present disclosure;

FIG. 2 is a framework diagram of performing a classification method based on an image classification model in an image classification method according to embodiments of the present disclosure;

FIG. 3 is a framework diagram of a training process of a first image encoder of an image classification model in an image classification method according to embodiments of the present disclosure;

FIG. 4 is a framework diagram of a training process of a text encoder and a feature matching layer of an image classification model in an image classification method according to embodiments of the present disclosure;

FIG. 5 is a schematic diagram of a structure of an image classification apparatus according to embodiments of the present disclosure; and

FIG. 6 is a schematic diagram of a structure of an electronic device according to embodiments of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations of the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not limiting, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

It should be understood that data (including but not limited to the data itself, and data acquisition, or usage) involved in the technical solutions should comply with the requirements of corresponding laws and regulations, and relevant stipulations.

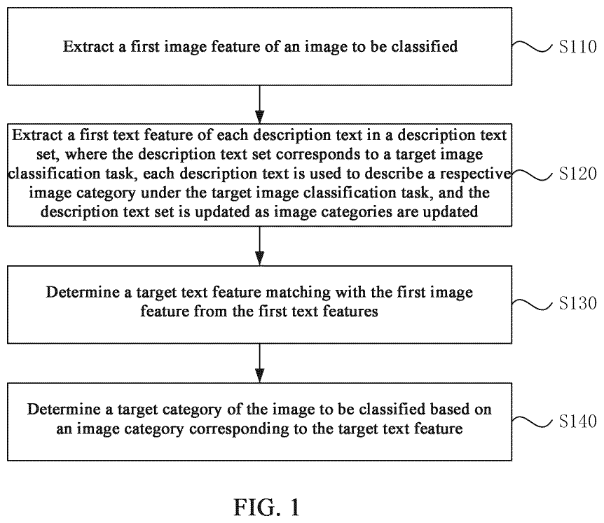

FIG. 1 is a schematic flowchart of an image classification method according to embodiments of the present disclosure. These embodiments of the present disclosure are applicable to a case of image classification, such as a case of classifying facial images into real facial images and fake facial images in silent liveness detection. The method may be performed by an image classification apparatus. The apparatus may be implemented in the form of software and/or hardware. The apparatus may be configured in an electronic device, such as a mobile phone and a computer.

As shown in FIG. 1, the image classification method according to these embodiments may comprise the following steps:
S110: A first image feature of an image to be classified is extracted.
S120: A first text feature of each description text in a description text set is extracted, wherein the description text set corresponds to a target image classification task, each description text is used to describe a respective image category under the target image classification task, and the description text set is updated as image categories are updated.
S130: A target text feature matching the first image feature is determined from the first text features.
S140: A target category of the image to be classified is determined based on an image category corresponding to the target text feature.

The image classification method according to these embodiments may be implemented through a trained deep learning model. The deep learning model may at least include a network structure for extracting image features, a network structure for extracting text features, and a network structure for matching image-text features, and the above network structures may be constructed based on existing relevant network structures.

Correspondingly, the first image feature of the image to be classified may be extracted through the network structure for extracting the image features; the first text feature of each description text is extracted through the network structure for extracting the text features; and a matching degree between each first text feature and the first image feature is determined through the network structure for matching the image-text features, and the first text feature with the highest matching degree may be used as the target text feature matched with the first image feature.

Different image classification tasks may correspond to different description text sets, and the description text set in these embodiments of the present disclosure may correspond to the target image classification task performed on the image to be classified. The target image classification task may include a task for dividing the image to be classified into at least two image categories; and correspondingly, the description text set may include description texts used to describe the at least two image categories under the target image classification task. The description text set may be updated as the image categories are updated. For example, when updates such as adding, deleting, and modifying are performed on image categories under the target image classification task, description texts in the description text set may be correspondingly newly added, deleted, and modified.

Exemplarily, Table 1 shows a description text set corresponding to a liveness detection task. Image categories under the liveness detection task may include subcategories in a real facial category under a parent category and subcategories in a fake facial category under the parent category; and correspondingly, the description text set may include subcategories for describing the real facial category and description texts for the subcategories of the fake facial category.

TABLE 1

| Parent | | |
|---|---|---|
| category | Subcategory | Description text |
| Fake facial | Screen replay subcategory | A face in an image is |
| category | | played on a screen |
| | Paper attack subcategory | A face in an image is printed |
| Real facial | Real facial subcategory | A face in an image is normal |
| category | | A face in an image is real |

Referring to Table 1, each subcategory may be considered as an image category, and each image category may correspond to at least one description text. The description text may be considered as an explanatory text corresponding to the image category and may be constructed based on experience or experiments. In some implementations, each image category may also correspond to at least two description texts. Therefore, multi-angle text descriptions of the image categories may be provided, thereby enhancing a subsequent image classification effect.

Moreover, for any parent category of the target image classification task, there may be a case where the parent category includes only one subcategory. For example, in Table 1, the parent category of the real facial category may not necessarily have a plurality of corresponding subcategories, and may be considered as a unique subcategory, and a corresponding text description is provided.

After being initially extracted, the first text features of the description texts may be stored in a preset storage space, and the first text features in the preset storage space may be updated as the description texts in the description text set are updated. Correspondingly, when the first image feature of the image to be classified that needs to be currently classified is extracted, the first text features corresponding to the description texts may also be directly acquired from the preset storage space. Therefore, it is possible to perform feature extraction only once on each currently updated description text and then perform feature matching with first image features of a plurality of images to be classified, thereby saving computational resources.

After determining the target text feature matched with the first image feature, the target category of the image to be classified that needs to be currently classified may be determined based on the image category corresponding to the description text from which the target text feature is extracted. For example, a subcategory corresponding to the description text from which the target text feature is extracted may be used as a target category of a facial image; alternatively, a parent category containing the subcategory corresponding to the description text from which the target text feature is extracted may be used as the target category of the facial image.

In these embodiments of the present disclosure, the update of the image categories may occur in any step period of the image classification method; and correspondingly, the description text set may be synchronously updated as the image categories are updated. In addition, when the description text set is updated (e.g., newly adding, deleting, and modifying internal description texts), the first text features corresponding to the description texts may also be updated in the preset storage space. Therefore, in the image classification process after the image category update, the first image feature of the image to be classified may be matched with the latest updated first text features in the preset storage space, thereby determining the target category of the image to be classified. In a case that the target category is the latest updated image category, the description text is used to rapidly model a new image category, and zero-sample prediction is completed through cross-modal feature matching, thereby achieving rapid recognition of the new image category.

In some optional implementations, the method is applied to an image classification model, and at least part of the image classification model is obtained based on knowledge distillation on a multimodal pre-trained model, wherein the multimodal pre-trained model is at least used to process data in image modality and text modality.

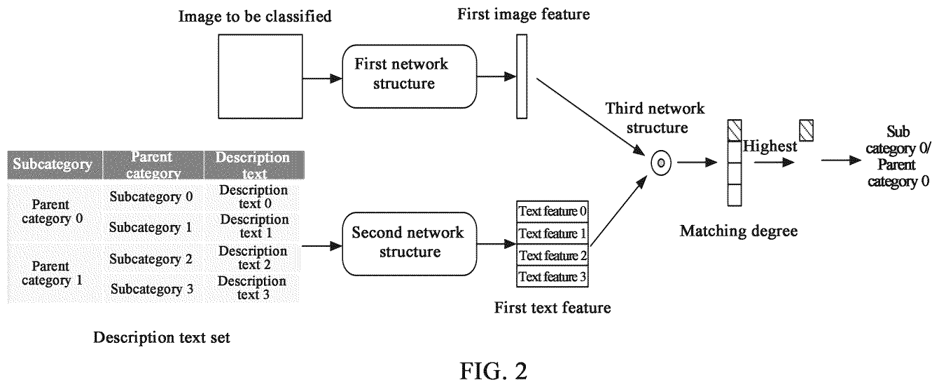

The deep learning model used to perform the image classification method in the present disclosure may be referred to as the image classification model. Exemplarily, FIG. 2 is a framework diagram of performing a classification method based on an image classification model in an image classification method according to embodiments of the present disclosure.

Referring to FIG. 2, the image classification model may at least include a first network structure for extracting image features, a second network structure for extracting text features, and a third network structure for matching image-text features. An image to be classified may be input into the first network structure to extract first image features; and a latest updated description text in a description text set may be input into the second network structure to extract first text features. The first image feature and the first text features may be input into the third network structure, to output a matching degree (e.g., a similarity vector) between each first text feature and the first image feature, and the first text feature with the highest matching degree may be used as a target text feature (e.g., a text feature 0 in FIG. 2) matched with the first image feature. Then, a target category is determined based on an image category corresponding to the target text feature. For example, in FIG. 2, a subcategory 0 or a parent category 0 may be determined as the target category.

The multimodal pre-trained model may be pre-trained based on large-scale and multimodal general sample data to obtain a capability of at least extracting data features of image modalities and text modalities, as well as a cross-modal feature matching capability at least including an image-text feature matching capability. Namely, the multimodal pre-trained model may be at least used to process the data of the image modalities and the text modalities. It may be considered that if the multimodal pre-trained model is trained for a downstream task based on training data relevant to the target image classification task, the trained multimodal pre-trained model may also be referred to as the image classification model, and may also implement the image classification method according to the present disclosure.

In addition, referring to the image classification model in FIG. 2 again, at least part of the first network structure, the second network structure, and the third network structure in the model may be obtained through knowledge distillation based on the multimodal pre-trained model. For example, the first network structure may be obtained through knowledge distillation based on a network structure for extracting image features in the multimodal pre-trained model. For another example, the second network structure and the third network structure may be obtained through knowledge distillation based on a network structure for extracting text features and a network structure for matching image-text features in the multimodal pre-trained model respectively. For yet another example, the first network structure, the second network structure, and the third network structure may all be obtained through knowledge distillation based on corresponding network structures in the multimodal pre-trained model.

In these optional implementations, for some image classification tasks, such as a liveness detection task, the amount of training data is often very limited. The multimodal pre-trained model is trained based on the large-scale general sample data, and the image classification model obtained on this basis (the image classification model obtained through methods such as downstream task training and knowledge distillation) will also possess the cross-modal feature matching capability with higher generalization. For the target image classification task with the limited training data, when there is a new image category, in a case of establishing a new description, the new image category and the new text description may also be accurately achieved, thereby recognizing the new image category. In addition, the image classification model obtained through the method of knowledge distillation is more lightweight compared to the multimodal pre-trained model, which is beneficial for improving computational efficiency and model deployment.

According to the technical solution in these embodiments of the present disclosure, the first image feature of the image to be classified is extracted; the first text feature of each description text in the description text set is extracted, where the description text set corresponds to the target image classification task, each description text is used to describe the image category under the target image classification task, and the description text set is updated as the image categories are updated; the target text feature matched with the first image feature is extracted from the first text features; and the target category of the image to be classified is determined based on the image category corresponding to the target text feature. Based on an image-text feature matching method, in a case of the new image category, rapid recognition of the new image category can be achieved simply by updating relevant description texts without an algorithm iteration process.

These embodiments of the present disclosure may be combined with various optional solutions in the image classification method according to the above embodiment. These embodiments provide a detailed description of steps for training the image classification model that performs the image classification method.

In these embodiments of the present disclosure, the image classification model may include a first image encoder, the multimodal pre-trained model may include a second image encoder, and a parameter amount of the first image encoder is less than a parameter amount of the second image encoder.

In this embodiment, the network structure for extracting the image features in the image classification model may be referred to as the first image encoder, and the network structure for extracting the image features in the multimodal pre-trained model may be referred to as the second image encoder. The parameter amount of the first image encoder is less than that of the second image encoder, which may include that the first image encoder has fewer network layers than the second image encoder, and/or each layer of the network may have fewer channels than the second image encoder. Therefore, by performing knowledge distillation training on the first image encoder, not only can an image encoding capability of the second image encoder be transferred to the first image encoder, but also a more lightweight image feature extraction network can be obtained.

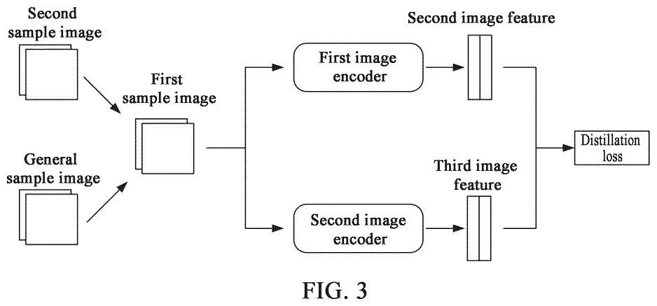

Exemplarily, FIG. 3 is a framework diagram of a training process of a first image encoder of an image classification model in an image classification method according to embodiments of the present disclosure. As shown in FIG. 3, in the image classification method according to these embodiments, the training process of the first image encoder may include:
encoding, by the first image encoder, a first sample image to obtain a second image feature. The first sample image includes a second sample image relevant to the target image classification task and may also include a general sample image, such as an image from an open-source database like Image Net, and the general sample image may be unrelated to the target image classification task. By performing distillation training on the image encoder of the image classification model using the general sample image and the second sample image relevant to the target image classification task, the generality of feature extraction by the image encoder in the image classification model can be enhanced.

A second image encoder encodes the first sample image to obtain a third image feature. There is no strict temporal relationship between the encoding process of the first image encoder and the encoding process of the second image encoder.

A distillation loss is determined according to the second image feature and the third image feature, and the first image encoder is trained according to the distillation loss. The distillation loss may be determined through an existing loss algorithm between feature images, such as a mean absolute loss (L1 Loss). Backpropagation may be performed based on the distillation loss to adjust parameters of the first image encoder, thereby achieving distillation training for the first image encoder.

The training framework shown in FIG. 3 may be considered valid only in a training phase of the first image encoder. After training is complete, only the first image encoder part is retained to extract the first image feature of the image to be classified. Due to a significant computational load of the image encoders in the image classification task, obtaining the image encoders in the image classification model through knowledge distillation of the image encoders in multimodal pre-training can greatly reduce the computational load of the image encoders in the image classification model, thereby improving the computational efficiency.

In these embodiments of the present disclosure, the image classification model may further include a text encoder and a feature matching layer in the multimodal pre-trained model.

After the multimodal pre-trained model is pre-trained based on the large-scale and multimodal general sample data, parameters of the text encoder and the feature matching layer inside may be assigned to the text encoder and the feature matching layer of the image classification model respectively. Then, the parameters of the text encoder and the feature matching layer of the image classification model may be adjusted based on second sample data relevant to the image classification task, to allow the text encoder and the feature matching layer of the image classification model to adapt to the image classification task.

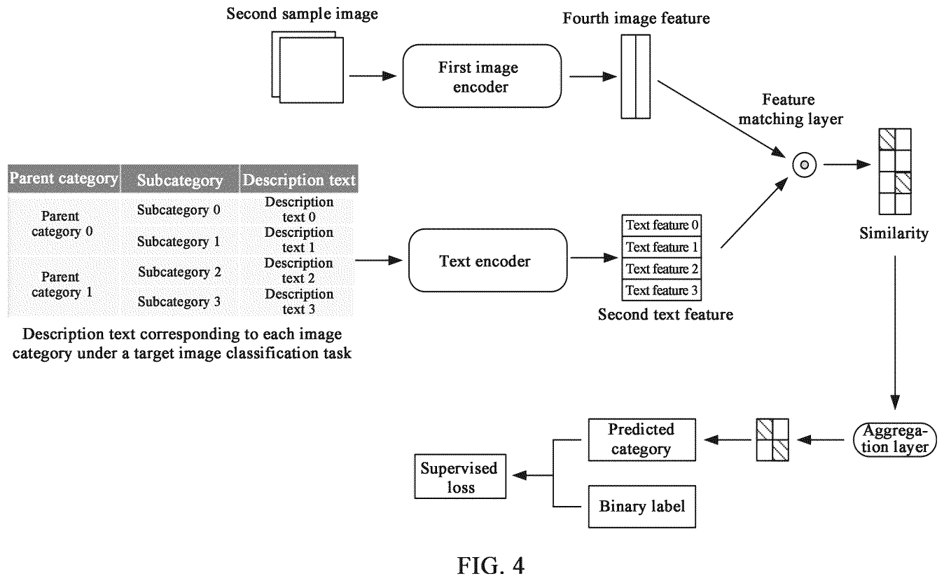

Exemplarily, FIG. 4 is a framework diagram of a training process of a text encoder and a feature matching layer of an image classification model in an image classification method according to embodiments of the present disclosure. As shown in FIG. 4, in the image classification method according to these embodiments, the training process of the text encoder and the feature matching layer may include:
extracting a fourth image feature of a second sample image relevant to the target image classification task. A first image encoder in the image classification model may be first trained, and then, the fourth image feature of the second sample image is extracted through the trained first image encoder. Alternatively, the first image encoder and the text encoder and the feature matching layer in the image classification model may be trained simultaneously, to extract the fourth image feature of the second sample image through the first image encoder that is currently trained.

The text encoder encodes each description text corresponding to each image category under the target image classification task to obtain second text features. Description texts in a description text set may be pre-constructed for the image categories under the target image classification task. Correspondingly, the description texts may be encoded through the text encoder to obtain the second text features.

A similarity between each second text feature and the fourth image feature is determined by the feature matching layer. The similarity may represent a matching degree between image-text features, and the higher similarity indicates a higher image-text matching degree.

A predicted category of the second sample image is determined according to the similarity. The predicted category of the second sample image may be determined typically based on an image category corresponding to the second text feature with the highest similarity.

A supervised loss is determined according to the predicted category and a category label corresponding to the second sample image, and the feature matching layer and the text encoder are trained according to the supervised loss. The predicted category of each second sample image may form a predicted category vector, and the category label corresponding to each second sample image may form a label vector. The supervised loss may be determined according to an existing loss algorithm between the vectors, such as a cross entropy loss (CE Loss). Backpropagation may be performed according to the supervised loss, to adjust the parameters of the text encoder and the feature matching layer of the image classification model, thereby achieving supervised training on the text encoder and the feature matching layer of the image classification model.

Since the text encoder has a relatively small computational load in the image classification task, only sample images relevant to the image classification task are used to adjust the parameters of the text encoder and the feature matching layer in multimodal pre-training, thereby adapting to the image classification task and also avoiding resource consumption caused by the part of distillation training.

In some optional implementations, the image categories under the target image classification task belong to subcategories of a binary parent category, and the category label corresponding to the second sample image is a binary label. Correspondingly, the step of determining a predicted category of the second sample image according to the similarities may include: fusing similarities corresponding to the image categories belonging to the same parent category to obtain a binary predicted category.

Referring to an example in Table 1, in a case that the target image classification task is the liveness detection task, the subcategories may be the image categories, and may respectively belong to the two parent categories: the fake facial category and the real facial category. The category label corresponding to the second sample image is the binary label, and may include two labels of the fake facial category and the real facial category.

Referring to FIG. 4 again, in these cases, an aggregation layer may be additionally set in the model training process to fuse the similarities corresponding to the image categories belonging to the same parent category, thereby obtaining the binary predicted category. In these optional implementations, by fusing the similarities under the same parent category, model supervised training according to the binary label can be achieved. Similarity fusion may be considered to be performed only in the training phase and not in a prediction phase, meaning that the aggregation layer set in the model may participate in the training process of the image classification model only as an auxiliary module to facilitate loss determination, rather than being a module that needs to be included during inference of the image classification model.

The technical solution in these embodiments of the present disclosure provides a detailed description of steps for training the image classification model that performs the image classification method. Due to a significant computational load of the image encoder in the image classification task, obtaining the image encoder in the image classification model through knowledge distillation of the image encoder in multimodal pre-training can greatly reduce the computational load of the image encoder in the image classification model, thereby improving the computational efficiency. Since the text encoder has a relatively small computational load in the image classification task, only sample images relevant to the image classification task are used to adjust the parameters of the text encoder and the feature matching layer in multimodal pre-training, thereby adapting to the image classification task and also avoiding resource consumption caused by the part of distillation training.

In addition, the image classification method according to these embodiments of the present disclosure and the image classification method according to the above embodiments belong to the same disclosure concept, and for technical details not described in detail in this embodiment, reference may be made to the above embodiment. The same technical features have the same beneficial effects in these embodiments and the above embodiments.

These embodiments of the present disclosure may be combined with various optional solutions in the image classification method according to the above embodiment. According to the image classification method according to these embodiments, the target image classification task may include silent liveness detection, and the image categories may include subcategories of the real facial category and subcategories of the fake facial category. By classifying facial images into real facial images and fake facial images, a basis for determining whether to perform subsequent businesses (e.g., account login, financial payments, and access control verification) may be provided for a system.

The image classification method according to these embodiments, when applied to the scenario of silent liveness detection, may include the following steps:
Firstly, a facial image is acquired. In this embodiment, the facial image may be considered as an image to be classified and may be captured by a camera of the system.
Then, a first image feature of the facial image is extracted. The first image feature of the facial image may be extracted through an image encoder in a liveness detection model (i.e., the image classification model).
Next, a first text feature of each description text in a description text set is extracted. The description text set corresponds to the silent liveness detection, and the description texts in the description text set may be used to describe the subcategories of the real facial category and the subcategories of the fake facial category under the silent liveness detection. Moreover, the description text set may be updated as the image categories are updated. Namely, once the subcategories of the real facial category and/or the subcategories of the fake facial category are updated, the description text set is correspondingly updated. For example, in some implementations, in response to an update instruction (e.g., add, delete, and modify update instructions) for the subcategories of the real facial category/the virtual facial category, the description texts corresponding to the subcategories of the real facial category/the virtual facial category in the description text set are correspondingly updated. After each update to the description text set, the first text feature of each description text in the updated description text set may be extracted through the text encoder in the liveness detection model and is stored in the preset storage space together with the description text. Correspondingly, the first text features corresponding to the description texts may be directly acquired from the preset storage space, thereby saving computational resources.
Then, the target text feature matched with the first image feature is determined from the first text features. The matching degree between each first text feature and the first image feature may be determined through the feature matching layer in the liveness detection model, and the first text feature with the highest matching degree may be used as the target text feature matched with the first image feature.
Finally, the target category of the image to be classified is determined based on the subcategory corresponding to the target text feature.

In these optional implementations, when a new fake face attack emerges, a subcategory of the fake facial category may be added for the new attack, and a description text of the newly-added subcategory is correspondingly constructed. A corresponding first text feature of the newly-added description text may be obtained through the text encoder in the liveness detection model and then may be matched with a first image feature of a subsequently acquired facial image, to detect whether the facial image belongs to the new subcategory. A feature center of a corresponding attack may be efficiently generated only by describing the attack in a case of lack of new attack training data. The attack is recalled in a feature matching manner, thereby greatly improving a defense capability against the image category of the new attack in the liveness detection task.

According to the technical solution in these embodiments of the present disclosure, the target image classification task may include the silent liveness detection, and the image categories may include the subcategories of the real facial category and the subcategories of the fake facial category. By classifying facial images into real facial images and fake facial images, a basis for determining whether to perform subsequent businesses (e.g., account login, financial payments, and access control verification) may be provided for a system. The image classification method according to these embodiments of the present disclosure and the image classification method according to the above embodiments belong to the same disclosure concept, and for technical details not described in detail in this embodiment, reference may be made to the above embodiment. The same technical features have the same beneficial effects in these embodiments and the above embodiment.

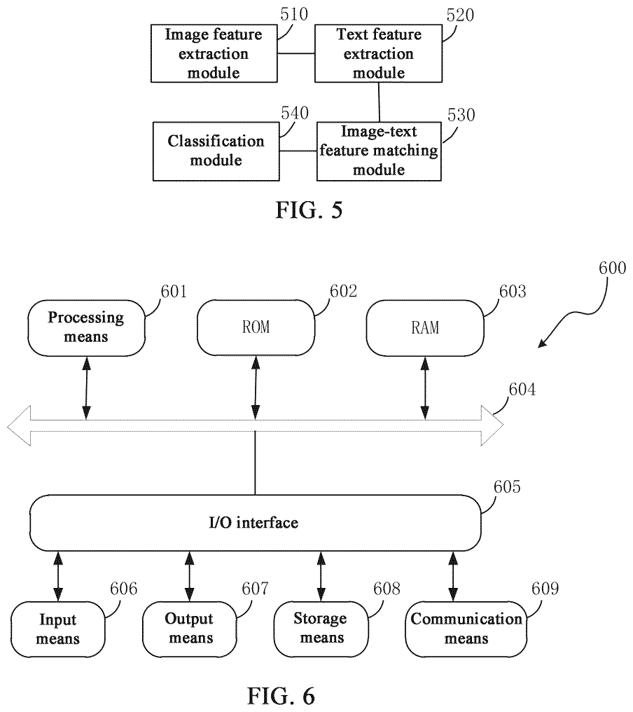

FIG. 5 is a schematic diagram of a structure of an image classification apparatus according to embodiments of the present disclosure. The image classification apparatus according to these embodiments is applicable to a case of image classification, such as a case of classifying facial images into real facial images and fake facial images in silent liveness detection.

As shown in FIG. 5, the image classification apparatus according to these embodiments of the present disclosure may include:
an image feature extraction module 510, configured to extract a first image feature of an image to be classified;
a text feature extraction module 520, configured to extract a first text feature of each description text in a description text set, wherein the description text set corresponds to a target image classification task, each description text is used to describe a respective image category under the target image classification task, and the description text set is updated as image categories are updated;
an image-text feature matching module 530, configured to determine a target text feature matching the first image feature from the first text features; and
a classification module 540, configured to determine a target category of the image to be classified based on an image category corresponding to the target text feature.

In some optional implementations, the method is applied to an image classification model, and at least part of the image classification model is obtained based on knowledge distillation on a multimodal pre-trained model, where the multimodal pre-trained model is at least used to process data in image modality and text modality.

In some optional implementations, the image classification model may include a first image encoder, the multimodal pre-trained model may include a second image encoder, and a parameter amount of the first image encoder is less than a parameter amount of the second image encoder.

Correspondingly, the image classification apparatus may further include:
a model training module, configured to train the first image encoder based on the following steps:
encoding, by the first image encoder, a first sample image to obtain a second image feature, the first sample image comprising a second sample image relevant to the target image classification task;
encoding, by the second image encoder, the first sample image to obtain a third image feature; and
determining a distillation loss according to the second image feature and the third image feature, and training the first image encoder according to the distillation loss.

In some optional implementations, the image classification model may include a text encoder and a feature matching layer in the multimodal pre-trained model; and
the model training module may be configured to train the text encoder and the feature matching layer based on the following steps:
extracting a fourth image feature of a second sample image relevant to the target image classification task;
encoding, by the text encoder, each description text corresponding to each image category under the target image classification task to obtain second text features;
determining, by the feature matching layer, a similarity between each second text feature and the fourth image feature;
determining a predicted category of the second sample image according to the similarity; and
determining a supervised loss according to the predicted category and a category label corresponding to the second sample image, and training the feature matching layer and the text encoder according to the supervised loss.

In some optional implementations, each image category under the target image classification task belongs to a subcategory of a binary parent category, and the category label is a binary label; and
correspondingly, determining the predicted category of the second sample image according to the similarity comprises: fusing similarities corresponding to the image categories belonging to the same parent category to obtain a binary predicted category.

In some optional implementations, each image category corresponds to at least two description texts.

In some optional implementations, the target image classification task may include silent liveness detection, and the image categories may include a subcategory of a real facial category and a subcategory of a fake facial category.

The image classification apparatus according to these embodiments of the present disclosure may perform the image classification method according to any embodiment of the present disclosure, and has the corresponding functional modules and beneficial effects for performing the method.

It should be noted that the various units and modules included in the above apparatus are only divided according to functional logics, but are not limited to the above division, as long as the corresponding functions can be achieved; and in addition, the specific names of the functional units are only for the convenience of distinguishing each other, and are not used to limit the scope of protection of the embodiments of the present disclosure.

Reference is made to FIG. 6 below, which is a schematic diagram of a structure of an electronic device (e.g., a terminal device or a server in FIG. 6) 600 suitable for implementing embodiments of the present disclosure. The terminal device in these embodiments of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing means (e.g., a central processing unit and a graphics processing unit) 601, which may perform various appropriate actions and processing according to a program stored in a read-only memory (ROM) 602 or a program loaded from a storage means 608 into a random access memory (RAM) 603. The RAM 603 further stores various programs and data required for the operation of the electronic device 600. The processing means 601, the ROM 602, and the RAM 603 are connected to one another through a bus 604. An input/output (I/O) interface 605 is also connected to the bus 604.

Typically, the following apparatuses may be connected to the I/O interface 605: an input means 606 including, for example, a touchscreen, a touchpad, a keyboard, a mouse, a camera, a microphone, an accelerometer, and a gyroscope; an output means 607 including, for example, a liquid crystal display (LCD), a speaker, and a vibrator; the storage means 608 including, for example, a magnetic tape and a hard drive; and a communication apparatus 609. The communication apparatus 609 may allow the electronic device 600 to be in wireless or wired communication with other devices for data exchange. Although FIG. 6 shows the electronic device 600 having various apparatuses, it should be understood that it is not required to implement or have all of the shown apparatuses. It may be an alternative to implement or have more or fewer apparatuses.

In particular, the above process described with reference to the flowcharts according to the embodiments of the present disclosure may be implemented as a computer software program. For example, embodiments of the present disclosure include a computer program product, which includes a computer program carried on a non-transitory computer-readable medium, where the computer program includes program code for performing the method shown in the flowchart. In this embodiment, the computer program may be downloaded and installed from the network through the communication apparatus 609, or installed from the storage means 608, or installed from the ROM 602. When the computer program is executed by the processing means 601, the above functions defined in the image classification method of the embodiments of the present disclosure are performed.

The electronic device according to these embodiments of the present disclosure and the image classification method according to the above embodiments belong to the same disclosure concept. For the technical details not exhaustively described in this embodiment, reference may be made to the above embodiments, and these embodiments and the above embodiments have the same beneficial effects.

Embodiments of the present disclosure provide a computer storage medium, having a computer program stored therein. The program, when executed by a processor, implements the image classification method according to the above embodiment.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM) or a flash, an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may also be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The above one or more programs, when executed by the electronic device, cause the electronic device to:
extract a first image feature of an image to be classified; extract a first text feature of each description text in a description text set, where the description text set corresponds to a target image classification task, each description text is used to describe a respective image category under the target image classification task, and the description text set is updated as image categories are updated; determine a target text feature matching the first image feature from the first text features; and determine a target category of the image to be classified based on an image category corresponding to the target text feature.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of the remote computer, the remote computer may be connected to the user computer through any kind of network, including a local area network (LAN) or a wide area network (WAN), or may be connected to an external computer (e.g., connected through the Internet with the aid of an Internet service provider).

The flowchart and the block diagram in the accompanying drawings illustrate the possibly implemented system architecture, functions, and operations of the system, the method, and the computer program product according to various embodiments of the present disclosure. In this regard, each block in the flowchart or the block diagram may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The names of the unit and the module do not limit the unit and the module in certain cases.

Herein, the functions described above may be at least partially executed by one or more hardware logic components. For example, without limitation, exemplary hardware logic components that can be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, an image classification method is provided and includes:
extracting a first image feature of an image to be classified;
extracting a first text feature of each description text in a description text set, wherein the description text set corresponds to a target image classification task, each description text is used to describe a respective image category under the target image classification task, and the description text set is updated as image categories are updated;
determining a target text feature matching the first image feature from the first text features; and
determining a target category of the image to be classified based on an image category corresponding to the target text feature.

According to one or more embodiments of the present disclosure, an image classification method is provided and further includes:
in some optional implementations, the method being applied to an image classification model, and at least part of the image classification model is obtained based on knowledge distillation on a multimodal pre-trained model, wherein the multimodal pre-trained model is at least used to process data in image modality and text modality.

According to one or more embodiments of the present disclosure, an image classification method is provided and further includes:
in some optional implementations, the image classification model including a first image encoder, the multimodal pre-trained model including a second image encoder, and a parameter amount of the first image encoder being less than that of the second image encoder,
where steps of training the first image encoder include:
encoding, by the first image encoder, a first sample image to obtain a second image feature, the first sample image comprising a second sample image relevant to the target image classification task;
encoding, by the second image encoder, the first sample image to obtain a third image feature; and
determining a distillation loss according to the second image feature and the third image feature, and training the first image encoder according to the distillation loss.

According to one or more embodiments of the present disclosure, an image classification method is provided and further includes:
in some optional implementations, the image classification model including a text encoder and a feature matching layer in the multimodal pre-trained model,
where steps of training the text encoder and the feature matching layer include:
extracting a fourth image feature of a second sample image relevant to the target image classification task;
encoding, by the text encoder, each description text corresponding to each image category under the target image classification task to obtain second text features;
determining, by the feature matching layer, a similarity between each second text feature and the fourth image feature;
determining a predicted category of the second sample image according to the similarity; and
determining a supervised loss according to the predicted category and a category label corresponding to the second sample image, and training the feature matching layer and the text encoder according to the supervised loss.

According to one or more embodiments of the present disclosure, an image classification method is provided and further includes:
in some optional implementations, each image category under the target image classification task belongs to a subcategory of a binary parent category, and the category label is a binary label; and
correspondingly, determining the predicted category of the second sample image according to the similarity comprises: fusing similarities corresponding to the image categories belonging to the same parent category to obtain a binary predicted category.

According to one or more embodiments of the present disclosure, an image classification method is provided and further includes:
in some optional implementations, each image category corresponds to at least two description texts.

According to one or more embodiments of the present disclosure, an image classification method is provided and further includes:
in some optional implementations, the target image classification task comprises silent liveness detection, and the image categories comprise a subcategory of a real facial category and a subcategory of a fake facial category.

According to one or more embodiments of the present disclosure, an image classification apparatus is provided, and includes:
an image feature extraction module, configured to extract a first image feature of an image to be classified;
a text feature extraction module, configured to extract a first text feature of each description text in a description text set, wherein the description text set corresponds to a target image classification task, each description text is used to describe a respective image category under the target image classification task, and the description text set is updated as image categories are updated;
an image-text feature matching module, configured to determine a target text feature matching the first image feature from the first text features; and
a classification module, configured to determine a target category of the image to be classified based on an image category corresponding to the target text feature.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments individually or in any suitable sub combination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

1. An image classification method, comprising:
extracting a first image feature of an image to be classified;
extracting a first text feature of each description text in a description text set, wherein the description text set corresponds to a target image classification task, each description text is used to describe a respective image category under the target image classification task, and the description text set is updated as image categories are updated;
determining a target text feature matching the first image feature from the first text features; and
determining a target category of the image to be classified based on an image category corresponding to the target text feature.

2. The method according to claim 1, wherein the method is applied to an image classification model, and at least part of the image classification model is obtained based on knowledge distillation on a multimodal pre-trained model, wherein the multimodal pre-trained model is at least used to process data in image modality and text modality.

3. The method according to claim 2, wherein the image classification model comprises a first image encoder, the multimodal pre-trained model comprises a second image encoder, and a parameter amount of the first image encoder is less than a parameter amount of the second image encoder,
wherein steps of training the first image encoder comprise:
encoding, by the first image encoder, a first sample image to obtain a second image feature, the first sample image comprising a second sample image relevant to the target image classification task;
encoding, by the second image encoder, the first sample image to obtain a third image feature; and
determining a distillation loss according to the second image feature and the third image feature, and training the first image encoder according to the distillation loss.

4. The method according to claim 2, wherein the image classification model comprises a text encoder and a feature matching layer of the multimodal pre-trained model,
wherein steps of training the text encoder and the feature matching layer comprise:
extracting a fourth image feature of a second sample image relevant to the target image classification task;
encoding, by the text encoder, each description text corresponding to each image category under the target image classification task to obtain second text features;
determining, by the feature matching layer, a similarity between each second text feature and the fourth image feature;
determining a predicted category of the second sample image according to the similarity; and
determining a supervised loss according to the predicted category and a category label corresponding to the second sample image, and training the feature matching layer and the text encoder according to the supervised loss.

5. The method according to claim 4, wherein each image category under the target image classification task belongs to a subcategory of a binary parent category, and the category label is a binary label; and
correspondingly, determining the predicted category of the second sample image according to the similarity comprises: fusing similarities corresponding to the image categories belonging to the same parent category to obtain a binary predicted category.

6. The method according to claim 1, wherein each image category corresponds to at least two description texts.

7. The method according to claim 1, wherein the target image classification task comprises silent liveness detection, and the image categories comprise a subcategory of a real facial category and a subcategory of a fake facial category.

8. (canceled)

9. An electronic device, comprising:
one or more processors; and
a storage, configured to store one or more programs,
the one or more programs, when executed by the one or more processors, causing the one or more processors to:
extract a first image feature of an image to be classified;
extract a first text feature of each description text in a description text set, wherein the description text set corresponds to a target image classification task, each description text is used to describe a respective image category under the target image classification task, and the description text set is updated as image categories are updated;
determine a target text feature matching the first image feature from the first text features; and
determine a target category of the image to be classified based on an image category corresponding to the target text feature.

10. A non-transitory storage medium comprising computer-executable instructions, the computer-executable instructions, when executed by a computer processor, causing a computer to:
extract a first image feature of an image to be classified;
extract a first text feature of each description text in a description text set, wherein the description text set corresponds to a target image classification task, each description text is used to describe a respective image category under the target image classification task, and the description text set is updated as image categories are updated;
determine a target text feature matching the first image feature from the first text features; and
determine a target category of the image to be classified based on an image category corresponding to the target text feature.

11. The electronic device according to claim 9, wherein at least part of the image classification model is obtained based on knowledge distillation on a multimodal pre-trained model, wherein the multimodal pre-trained model is at least used to process data in image modality and text modality.

12. The electronic device according to claim 11, wherein the image classification model comprises a first image encoder, the multimodal pre-trained model comprises a second image encoder, and a parameter amount of the first image encoder is less than a parameter amount of the second image encoder,
wherein the one or more programs cause the one or more processors to train the first image encoder by causing the one or more processors to:
encode, by the first image encoder, a first sample image to obtain a second image feature, the first sample image comprising a second sample image relevant to the target image classification task;
encode, by the second image encoder, the first sample image to obtain a third image feature; and
determine a distillation loss according to the second image feature and the third image feature, and train the first image encoder according to the distillation loss.

13. The electronic device according to claim 11, wherein the image classification model comprises a text encoder and a feature matching layer of the multimodal pre-trained model,
wherein the one or more programs cause the one or more processors to train the text encoder and the feature matching layer by causing the one or more processors to:
extract a fourth image feature of a second sample image relevant to the target image classification task;
encode, by the text encoder, each description text corresponding to each image category under the target image classification task to obtain second text features;
determine, by the feature matching layer, a similarity between each second text feature and the fourth image feature;
determine a predicted category of the second sample image according to the similarity; and
determine a supervised loss according to the predicted category and a category label corresponding to the second sample image, and training the feature matching layer and the text encoder according to the supervised loss.

14. The electronic device according to claim 13, wherein each image category under the target image classification task belongs to a subcategory of a binary parent category, and the category label is a binary label; and
correspondingly, the one or more programs causing the one or more processors to determine the predicted category of the second sample image according to the similarity cause the one or more processors to: fuse similarities corresponding to the image categories belonging to the same parent category to obtain a binary predicted category.

15. The electronic device according to claim 9, wherein each image category corresponds to at least two description texts.

16. The electronic device according to claim 9, wherein the target image classification task comprises silent liveness detection, and the image categories comprise a subcategory of a real facial category and a subcategory of a fake facial category.

17. The medium according to claim 10, wherein at least part of the image classification model is obtained based on knowledge distillation on a multimodal pre-trained model, wherein the multimodal pre-trained model is at least used to process data in image modality and text modality.

18. The medium according to claim 17, wherein the image classification model comprises a first image encoder, the multimodal pre-trained model comprises a second image encoder, and a parameter amount of the first image encoder is less than a parameter amount of the second image encoder,
wherein the instructions cause the computer to train the first image encoder, and the instructions causing the computer to train the first image encoder comprise instructions causing the computer to:
encode, by the first image encoder, a first sample image to obtain a second image feature, the first sample image comprising a second sample image relevant to the target image classification task;
encode, by the second image encoder, the first sample image to obtain a third image feature; and
determine a distillation loss according to the second image feature and the third image feature, and training the first image encoder according to the distillation loss.

19. The medium according to claim 17, wherein the image classification model comprises a text encoder and a feature matching layer of the multimodal pre-trained model,
wherein the instructions cause the computer to train the text encoder and the feature matching layer, and the instructions causing the computer to train the text encoder and the feature matching layer comprise instructions causing the computer to:
extract a fourth image feature of a second sample image relevant to the target image classification task;
encode, by the text encoder, each description text corresponding to each image category under the target image classification task to obtain second text features;
determine, by the feature matching layer, a similarity between each second text feature and the fourth image feature;
determine a predicted category of the second sample image according to the similarity; and
determine a supervised loss according to the predicted category and a category label corresponding to the second sample image, and train the feature matching layer and the text encoder according to the supervised loss.

20. The medium according to claim 19, wherein each image category under the target image classification task belongs to a subcategory of a binary parent category, and the category label is a binary label; and
correspondingly, the instructions causing the computer to determine the predicted category of the second sample image according to the similarity comprise instructions causing the computer to: fuse similarities corresponding to the image categories belonging to the same parent category to obtain a binary predicted category.

21. The medium according to claim 10, wherein each image category corresponds to at least two description texts.
